(19) United States
(12) Patent Application Publication
(10) Pub. No.: US 2010/0199264 A1
(43) Pub. Date: Aug. 5, 2010

(54) PATTERN INSPECTION SYSTEM, PATTERN INSPECTION DEVICE, METHOD AND PATTERN INSPECTION PROGRAM

(76) Inventor: Naoto Maeda, Tokyo (JP)

Correspondence Address: Mr. Jackson Chen, 6535 N. STATE HWY 161, IRVING, TX, 75039, US

(21) Appl. No.: 12/671,010

(22) PCT Filed: Aug. 1, 2008
(86) PCT No.: PCT/JP2008/063895

§ 371 Date: Jan. 27, 2010

(30) Foreign Application Priority Data
Aug. 2, 2007 (JP) 2007 201584

(51) Int. Cl. G06F 9/44

(52) U.S. Cl. 717/127; 717/125

(57) ABSTRACT

With a program described in an object-oriented language as a target, it is inspected by program analysis whether a pattern of a method call issued to a specific object generated at the time of execution conforms to a given rule of pattern definition or not.

The pattern inspection system for inspecting, with a program described in an object-oriented language as a target, a method calling pattern issued to an object generated when the program is executed, which includes an extraction unit for extracting an abstract object related to inspection from abstract objects recorded in program information of the program by referring to an inspection target class name described in pattern definition, a determination unit for determining a method calling place at which a method call related to inspection is made to the abstract object by using a pointer analysis result taking a context of the program into consideration, and an inspection unit for generating a control flow graph bridging over functions and executing data flow analysis to inspect whether the method calling pattern conforms to the pattern definition or not.

### TECHNICAL FIELD

The present invention relates to a pattern inspection system, a pattern inspection method, and a recording medium which records a pattern inspection program and, more particularly, a pattern inspection system, a pattern inspection device, a pattern inspection method and a pattern inspection program which enable a pattern to be inspected with high precision by using a pointer analysis result taking context into consideration.

### BACKGROUND ART

In general, a pattern inspection system of this kind inspects occurrence/non-occurrence of a function call on an appropriate pattern in a program when the program is executed.

As an example of a related pattern inspection system, one example of an inspection system is recited in each of Patent Literature 1 and Non-Patent Literature 1, which analyzes a source code of a program and without actually executing the program, analyzes a behavior at the time of the execution. One example of an inspection system which monitors and inspects a behavior of a program during the execution of the program is recited in Patent Literature 2.

Thus, as a method of inspecting a pattern, there exist two kinds of methods, a method of analyzing a program without executing the same and a method of detection by monitoring a program while its execution. Among them, the method of detecting abnormality by monitoring operation of a program while its execution which is recited in Patent Literature 2 has a problem of involving reduction in a program execution rate.

In the following, more detailed description will be made of an inspection system which analyzes a program without executing the same as related art.

An inspection system of this kind, when accepting a program and a rule of a function calling pattern as input, determines whether the applied program conforms to a function calling pattern which is given at the time of execution or not by analyzing the program and outputs a determination result.

Such an inspection system comprises a syntax analysis unit for analyzing syntax of a program, an in-function control flow graph generation unit for generating a control flow in a function, a between-function control flow graph generation unit for generating a control flow graph bridging over functions, a path inspection unit for inspecting whether an applied path is appropriate or not, and a data flow analysis unit for inspecting whether a pattern is conformed to or not by using an in-function control flow graph and the path inspection unit.

Operation of the inspection system will be described more specifically with reference to an example shown in FIG. 2. Program example in FIG. 2 is a source code of a program described in an object-oriented language.

The syntax analysis unit analyzes a source code of a program to discriminate each element such as a sentence, an expression or a control structure forming the program according to grammar of a programming language. The in-function control flow graph generation unit generates an in-function control flow graph on a method basis.

The in-function control flow graph is a directed graph which, with each sentence of a program as a node, is obtained by connecting a node by a directed side according to a flow of program control. In a case of the program example shown in FIG. 2, an in-function control flow graph is generated with respect to each of methods, main and func.

The between-function control flow graph generation unit generates a between-function control flow graph with an in-function control flow graph of each method connected according to a method call. In the example shown in FIG. 2, the func method is called up from the main method. Therefore, from a node of an in-function control flow graph corresponding to a sentence which calls the func method in main, set up a directed side to a start node (entry) of the func method and set up a directed side from an end node (exit) of the func method to a corresponding call return place. Since there exist two calls, a total of four directed sides, a path 1, a path 2, a path 3 and a path 4, are added in FIG. 2.

The data flow analysis unit inspects a pattern by using thus obtained between-function control flow graph. In the between-function control flow graph, there exists a path that cannot exist in actual program execution such as a path from the path 1 to the path 4 or a path from the path 3 to the path 2. Since these paths are paths that will not return to a proper return place corresponding to a function call and that cannot be generated at the time of program execution, they can be factors causing reduction in inspection precision.

Under these circumstances, the data flow analysis unit, when a path is applied, uses the path inspection unit which determines whether a function calling node and a return node appearing on the path appropriately correspond to each other or not to inspect only a path determined to be appropriate by the path inspection unit. When analyzing a function calling pattern that might be generated with respect to every appropriate path by using data flow analysis, the data flow analysis unit inspects whether the pattern conforms to applied pattern definition. When there exists a pattern not conforming to the definition, indicate to that effect.

Patent Literature 1: Japanese Patent Laying-Open No. 2004-145381 (FIG. 1).

Patent Literature 2: Japanese Patent Laying-Open No. 2002-333992 (FIG. 1).

Non-Patent Literature 1: Thomas Reps and other two persons, “Precise Interprocedural Dataflow Analysis via Graph Reachability”, U.S.A, 1995, ACM POPL' 95, pp. 49-61.

First problem is that the above-described related inspection system fails to inspect a function (method) calling pattern bridging over functions (methods) of a program described in an object-oriented language.

The reason is that although an object-oriented language requires inspection of a method calling order issued to a specific object, the above-described related path inspection system takes into consideration only a function calling order but not which target (data recorded on a memory) the function affects.

Accordingly, the above-described related inspection system fails to determine which object each reference variable (pointer variable) appearing in a program indicates during execution. As a result, when inspecting an object-oriented language, such erroneous determination will be frequently made as determination that a program is erroneous although it is proper or determination that a program is proper although it is erroneous, resulting in preventing significant inspection.

In the example shown in FIG. 2, for example, there are an R object generated on the first line and an R object generated on the third line. The related inspection system fails to determine whether a release method calling called up in func refers to the object generated on the first line or refers to the object generated on the third line.

Second problem is that no determination is possible whether on a specific execution path, a reference variable appearing in a method which appears on the path refers to a specific object or not.

The reason is that the above-described related inspection system takes only a function calling corresponding relationship into consideration.

In the example shown in FIG. 2, while the inspection system finds that there are two types of routes, the route 1 and the route 2, and the route 3 and the route 4, it fails to discriminate, in a case of the relevant path, which object is to be referred to by a reference variable p in func included in the path.

For inspecting a pattern with high precision, the inspection system should find that when func is called up by the route 1, p indicates the R-type object generated on the first line and when func is called up by the route 3, p indicates the R-type object generated on the third line.

### OBJECT OF THE INVENTION

An object of the present invention is to provide a pattern inspection system which enables, with a program described in an object-oriented language as a target, a method calling pattern issued to an object generated when the program is executed to be inspected bridging over functions without executing the program.

Another object of the present invention is to provide a pattern inspection system which inspects a method calling pattern issued to a specific object with high precision.

### SUMMARY

A pattern inspection system according to a first exemplary aspect of the invention for inspecting, with a program described in an object-oriented language as a target, a method calling pattern issued to an object generated when the program is executed, includes a unit for identifying a calling place at which a method call related to inspection is made to an object to be inspected by using a pointer analysis result taking a context of the program into consideration.

A pattern inspection system according to a second exemplary aspect of the invention for inspecting, with a program described in an object-oriented language as a target, a method calling pattern issued to an object generated when the program is executed, includes an extraction unit for extracting an abstract object related to inspection from abstract objects recorded in program information of the program by referring to an inspection target class name described in pattern definition, a determination unit for determining a method calling place at which a method call related to inspection is made to the abstract object by using a pointer analysis result taking a context of the program into consideration, and an inspection unit for inspecting whether the method calling pattern conforms to the pattern definition or not by generating a control flow graph bridging over functions and executing data flow analysis.

A pattern inspection device according to a first exemplary aspect of the invention for inspecting, with a program described in an object-oriented language as a target, a method calling pattern issued to an object generated when the program is executed, includes a unit for identifying a calling place at which a method call related to inspection is made to an object to be inspected by using a pointer analysis result taking a context of the program into consideration.

A pattern inspection device according to a second exemplary aspect of the invention for inspecting, with a program described in an object-oriented language as a target, a method calling pattern issued to an object generated when the program is executed, includes an extraction unit for extracting an abstract object related to inspection from abstract objects recorded in program information of the program by referring to an inspection target class name described in pattern definition, a determination unit for determining a method calling place at which a method call related to inspection is made to the abstract object by using a pointer analysis result taking a context of the program into consideration, and an inspection unit for inspecting whether the method calling pattern conforms to the pattern definition or not by generating a control flow graph bridging over functions and executing data flow analysis.

A pattern inspection method according to a first exemplary aspect of the invention of inspecting, with a program described in an object-oriented language as a target, a method calling pattern issued to an object generated when the program is executed, includes a step of identifying a calling place at which a method call related to inspection is made to an object to be inspected by using a pointer analysis result taking a context of the program into consideration.

A pattern inspection method according to a second exemplary aspect of the invention of inspecting, with a program described in an object-oriented language as a target, a method calling pattern issued to an object generated when the program is executed, includes a step of extracting an abstract object related to inspection from abstract objects recorded in program information of the program by referring to an inspection target class name described in pattern definition, a step of determining a method calling place at which a method call related to inspection is made to the abstract object by using a pointer analysis result taking a context of the program into consideration, and a step of generating a control flow graph bridging over functions and executing data flow analysis to inspect whether the method calling pattern conforms to the pattern definition or not.

A computer-readable recording medium according to a first exemplary aspect of the invention storing a pattern inspection program which is executed on a computer for inspecting, with a program described in an object-oriented language as a target, a method calling pattern issued to an object generated when the program is executed, wherein

the pattern inspection program causes the computer to execute the processing of identifying a calling place at which a method call related to inspection is made to an object to be inspected by using a pointer analysis result taking a context of the program into consideration.

A computer-readable recording medium according to a second exemplary aspect of the invention storing a pattern inspection program which is executed on a computer for inspecting, with a program described in an object-oriented language as a target, a method calling pattern issued to an object generated when the program is executed, wherein the pattern inspection program causes the computer to execute the processing of a processing of extracting an abstract object related to inspection from abstract objects recorded in program information of the program by referring to an inspection target class name described in pattern definition a processing of determining a method calling place at which a method call related to inspection is made to the abstract object by using a pointer analysis result taking a context of the program into consideration, and a processing of generating a control flow graph bridging over functions and executing data flow analysis to inspect whether the method calling pattern conforms to the pattern definition or not.

First effect is to enable a pattern of a method issued to a specific abstract object in a function or bridging over functions to be inspected.

The reason is that a calling pattern of a method call issued to a specific abstract object as an inspection target is inspected while taking into consideration which abstract object is to be referred to by a reference variable appearing in a program at the time of program execution.

Second effect is to reduce an error detection rate in pattern inspection.

The reason is that whether a reference variable appearing in each method in a developed call graph refers to an abstract object to be inspected is determined by using a pointer analysis result taking a context into consideration and only when the object is to be referred to in practice, the method call is considered to occur.

### BRIEF DESCRIPTION OF THE DRAWINGS

FIG. 1 is a block diagram showing a structure of a pattern inspection system according to a first exemplary embodiment of the present invention;

FIG. 2 is a diagram showing an example of a sample program and a control flow graph bridging over its functions;

FIG. 3 is a diagram showing an example of a structure of pattern definition according to the first exemplary embodiment of the present invention;

FIG. 4 is a diagram showing an example of a structure of a pointer analysis result according to the first exemplary embodiment of the present invention;

FIG. 5 is a diagram showing an example of a structure of an abstract object according to the first exemplary embodiment of the present invention;

FIG. 6 is a diagram showing an example of a structure of a method calling place according to the first exemplary embodiment of the present invention;

FIG. 7 is a diagram showing an example of a structure of a directed graph according to the first exemplary embodiment of the present invention;

FIG. 8 is a diagram showing an example of a structure of a pointer analysis result according to a second exemplary embodiment of the present invention;

FIG. 9 is a diagram showing an example of a structure of a context abstract object according to the second exemplary embodiment of the present invention;

FIG. 10 is a flow chart showing operation according to the first exemplary embodiment of the present invention;

FIG. 11 is a flow chart showing details of operation of a call graph development unit according to the first exemplary embodiment of the present invention;

FIG. 12 is a flow chart showing details of operation of an inspection graph generation unit according to the first exemplary embodiment of the present invention;

FIG. 13 is a flow chart showing details of operation of the inspection graph generation unit by using an object-sensitive pointer analysis result according to the first exemplary embodiment of the present invention;

FIG. 14 is a flow chart showing details of operation of the inspection graph generation unit by using a CFA-type pointer analysis result according to the first exemplary embodiment of the present invention;

FIG. 15 is a flow chart showing details of operation of the inspection graph generation unit by using an object-sensitive pointer analysis result according to the second exemplary embodiment of the present invention;

FIG. 16 is a flow chart showing details of operation of the inspection graph generation unit by using a CFA-type pointer analysis result according to the second exemplary embodiment of the present invention; and

FIG. 17 is a block diagram showing a hardware structure of a pattern inspection device according to the first exemplary embodiment of the present invention.

### EXEMPLARY EMBODIMENT

Next, exemplary embodiments of the present invention will be detailed with reference to the drawings.

### First Exemplary Embodiment

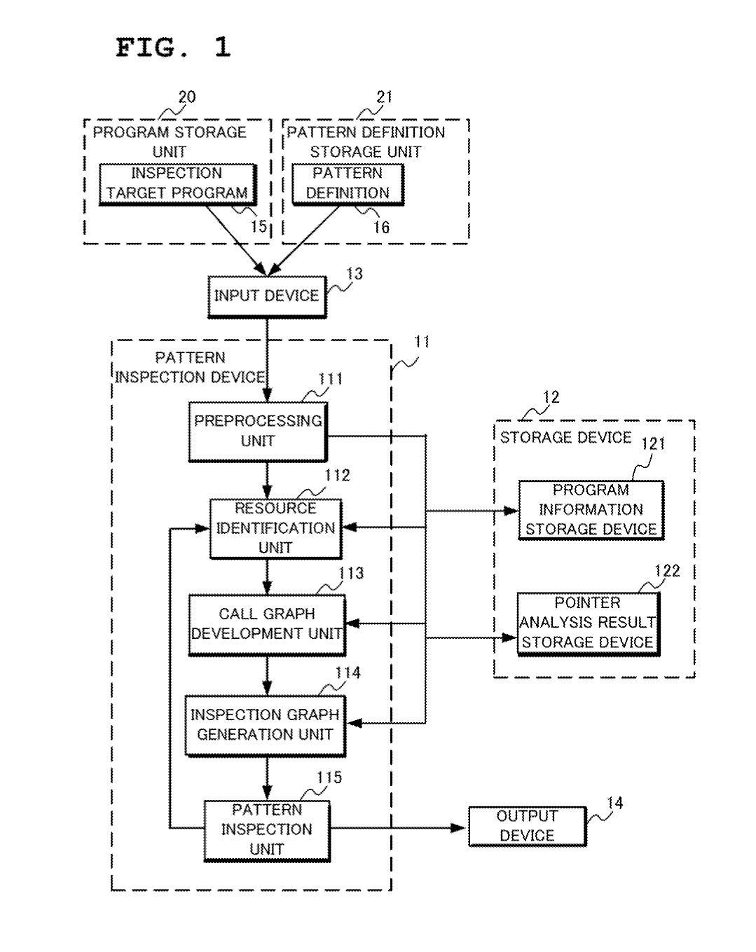

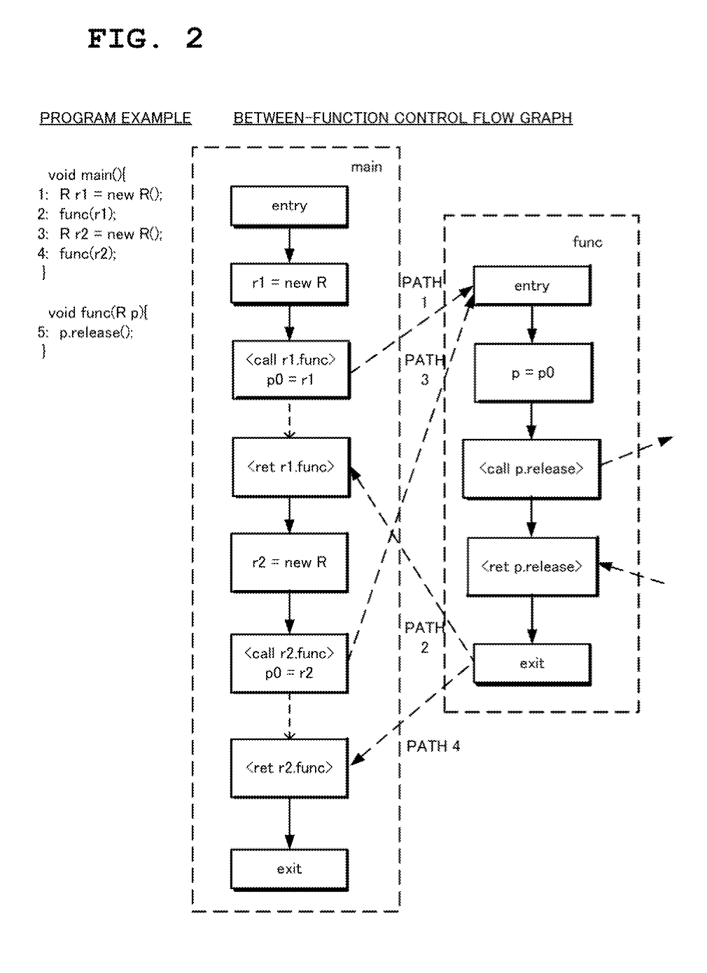

With reference to FIG. 1, a pattern inspection system according to a first exemplary embodiment of the present invention includes a pattern inspection device 11 operable under the control of a program, a storage device 12 for storing information, an input device 13 such as a keyboard, an output device 14 such as a display device or a printer device, a program storage unit 20 for storing an inspection target program 15 such as a file which stores a program described in an object-oriented language, and a pattern definition storage unit 21 for storing a pattern definition 16 of a file or the like which stores an inspection pattern.

The inspection target program 15 is a program described in an object-oriented language such as Java or C#, whose code format may be a source code as of before compiling or an execution code as of after compiling.

The pattern definition 16 is a description of a method calling pattern rule to be issued to a certain object, which may be defined uniquely by a pattern inspection system user or may be incorporated into the pattern inspection system in advance.

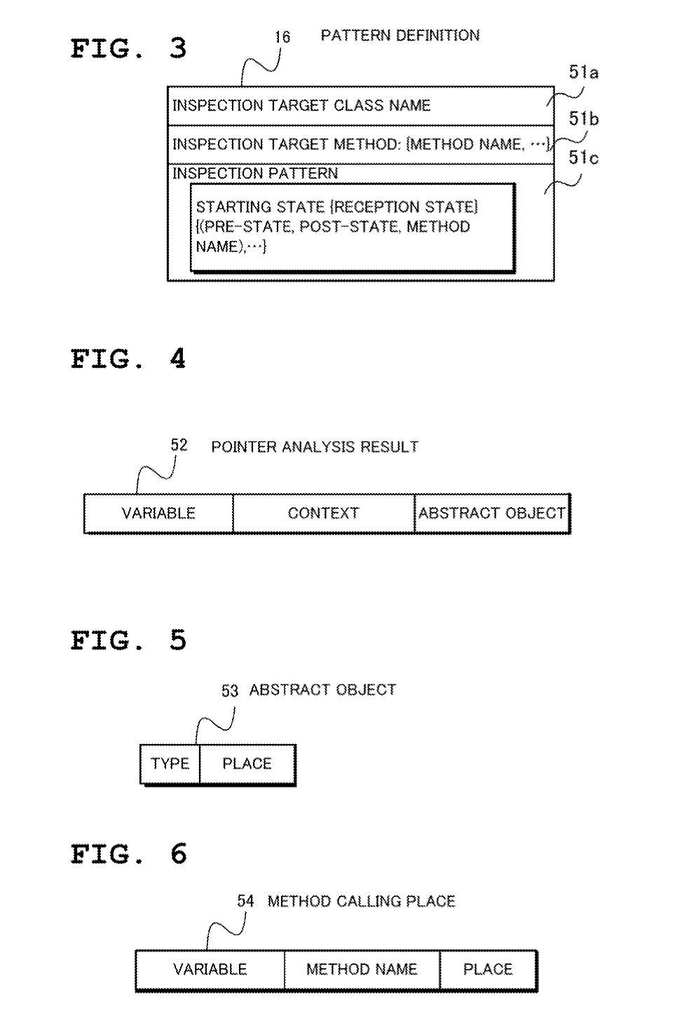

One example of the pattern definition 16 is shown in FIG. 3. The pattern definition 16 is formed of an inspection target class name 51a, an inspection target method 51b and an inspection pattern 51c. The inspection target class name 51a indicates a class of an object that should conform to the calling pattern. The inspection target method 51b indicates a set of methods related to a pattern. The inspection pattern 51c indicates a pattern to be conformed to when the method is issued to the object.

The inspection pattern 51c can be described, for example, as a definite automaton. Definite automaton is formed of a state, a side linking a state, and a label assigned to a side and has one starting state and a plurality of reception states. Since transition from a certain state to another state occurs due to a method call, a transition relationship of a definite automaton can be expressed by a set of three, a pre-state, a post-state and a method.

When a string of method calls issued to a specific object in a certain series of execution is received by the definite automaton expressing an inspection pattern, determination is made that the execution series conforms to a rule of a method call pattern with respect to the object.

Each element forming the pattern inspection device 11 will be outlined with reference to FIGS. 1, 4, 5, 6 and 7.

A preprocessing unit 111 analyzes the inspection target program 15 and preserves various kinds of program information necessary for pattern inspection into a program information storage device 121 and further applies pointer analysis taking a context into consideration to the inspection target program 15 to preserve a pointer analysis result 52 in a pointer analysis result storage device 122.

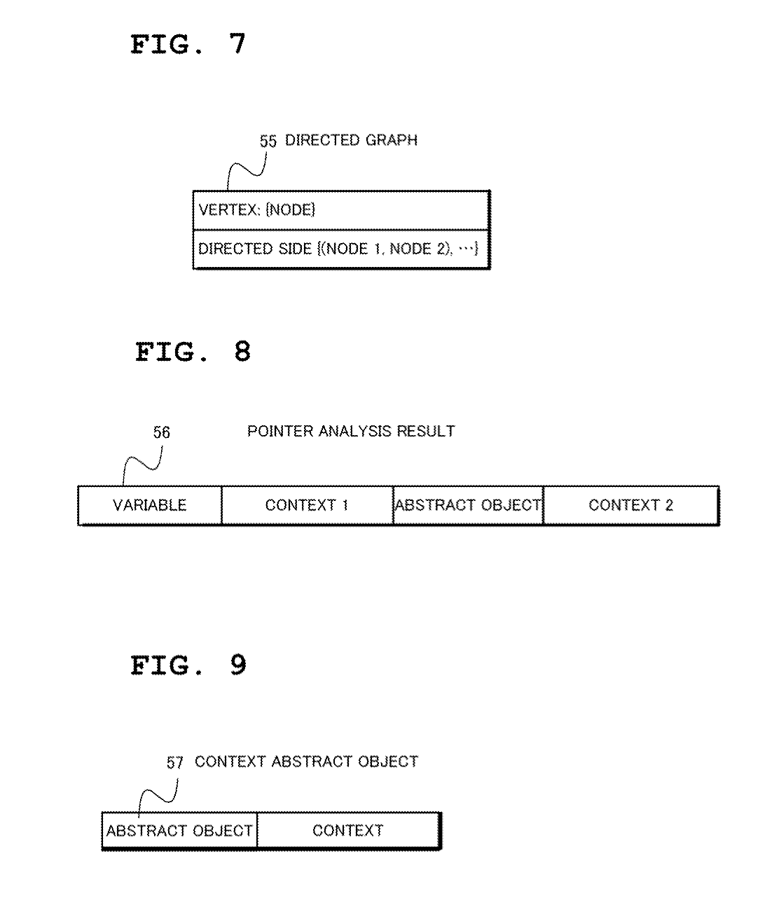

The program information includes a method calling place 54 (see FIG. 6) in which a place where a method call occurs in a program is recorded, an abstract object 53 (see FIG. 5) in which a place where an object is generated and a type of object generated are recorded in correlation with each other, and a call graph (see a directed graph 55 in FIG. 7) in which a method calling relationship is recorded. The call graph can be expressed by such a structure of the directed graph 55 as shown in FIG. 7. Node in the call graph corresponds to a method. When a certain method A calls up a method B, a directed side of the call graph includes a pair (A, B) of the methods A and B.

Example of a structure of the pointer analysis result 52 is shown in FIG. 4. The pointer analysis result 52 is formed of three, a variable, a context and an abstract object. When there is a possibility that the variable will refer to an abstract object in the context, the set of three is included in the pointer analysis result.

A resource identification unit 112 reads information related to the abstract object 53 indicative of an object generation place from the program information storage device 121 to identify a generation place of an object to be inspected which is designated by the pattern definition 16.

A set of objects to be inspected will be specifically referred to as a resource. An identified resource is one-to-one correlated with the abstract object 53. When obtaining a set of resources, that is, a set of the abstract objects 53 to be inspected, the resource identification unit 112 sends the abstract objects 53 included in the set one by one to a call graph development unit 113 and when obtaining a notification of completion of inspection of the relevant abstract object 53 by a pattern inspection unit 115, sends the abstract object 53 yet to be processed again to the call graph development unit 113. Upon completion of the processing of all the abstract objects 53, inspection processing will be completed.

Upon receiving one abstract object 53 from the resource identification unit 112, the call graph development unit 113 reads a call graph from the program information storage device 121 to develop the read call graph.

The call graph development unit 113 serves to make method calls correspond to each other similarly to the path inspection unit of a common pattern inspection system. The developed call graph and the abstract object 53 sent from the resource identification unit 112 are sent to an inspection graph generation unit 114.

The call graph development unit 113 further reads the method calling place 54 from the program information storage device 121 to calculate a set of the method calling places 54 related with pattern inspection which is issued to the abstract object with reference to pattern definition corresponding to the abstract object 53 and sends a result to the inspection graph generation unit 114.

Upon receiving the abstract object 53, the developed call graph and the set of method calling places 54 related to the inspection, the inspection graph generation unit 114 reads the pointer analysis result 52 from the pointer analysis result storage device 122.

The inspection graph generation unit 114 determines whether a variable of the method calling place 54 related to an inspection appearing in the developed call graph refers to the abstract object 53 in a context applied by the developed call graph by using the pointer analysis result 52.

Then, a combination between a node of the developed call graph and the method calling place 54 determined to refer to the abstract object 53 is sent to the pattern inspection unit 115. The developed call graph is also sent to the pattern inspection unit 115.

Upon receiving the developed call graph and a set of combinations between the nodes and the method calling places 54 of the developed call graph, the pattern inspection unit 115 sets up a between-function control flow graph and determines whether a pattern of a method calling issued to the abstract object 53 conforms to a rule defined by the pattern definition 51 or not by data flow analysis to output a determination result to the output device 14.

In the structure of the pattern inspection device 11 shown in FIG. 1, only characteristic components of the present invention are shown and illustration of the other components are omitted for the simplification of description.

Here, a hardware structure of the pattern inspection device 11 will be described.

FIG. 17 is a block diagram showing a hardware structure of the pattern inspection device 11 according to the first exemplary embodiment.

With reference to FIG. 17, the pattern inspection device 11, which can be realized by the same hardware structure as that of a common computer device, comprises a CPU (Central Processing Unit) 301, and a main storage unit 302 which is a main memory such as RAM (Random Access Memory) for use as a data working region or a data temporary saving region.

Further provided are a communication control unit 303 for transmitting/receiving information on a network, a display unit 304 such as a liquid crystal display, a printer or a display device, an input unit 305 such as a keyboard or a mouse, an interface unit 306 connected to a peripheral apparatus for transmitting/receiving data, a subsidiary storage unit 307 formed of a non-volatile memory such as a ROM (Read Only Memory), a magnetic disk or a semiconductor memory, and a system bus 308 which connects the above-described respective components of the present information processing device with each other. For example, as the subsidiary storage unit 307, the storage device 12 according to the present exemplary embodiment can be included.

The pattern inspection device 11 according to the present exemplary embodiment has its operation realized not only in hardware by mounting a circuit part formed of a hardware part such as LSI (Large Scale Integration) having a program realizing the functions of the above-described respective components incorporated but also in software by executing the program which provides each function of the above-described components by the CPU 301 on the computer processing device.

More specifically, the CPU 301 loads a program stored in the subsidiary storage unit 307 into the main storage unit 302 and executes the same to control operation of the pattern inspection device 11, thereby realizing each of the above-described functions in software.

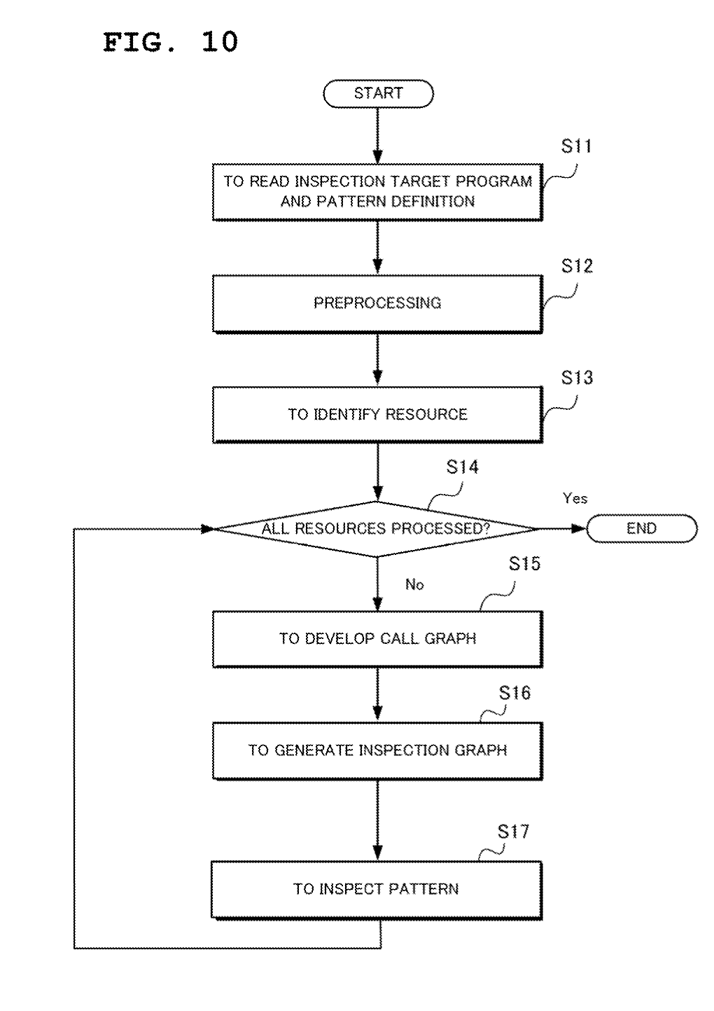

Next, entire operation of the present exemplary embodiment will be detailed with reference to FIG. 1 and the flow chart in FIG. 10.

First, the inspection target program 15 and the pattern definition 16 are read into the pattern inspection device 11 by using the input device 13 (Step S11).

Next, the preprocessing unit 111 applies basic analysis such as word analysis and syntax analysis to the inspection target program 15 to record the abstract object 53, the method calling place 54 or an in-function control flow graph in a method into the program information storage device 121 (Step S12).

The in-function control flow graph is a directed graph which, with a sentence as a minimum execution unit of a program as a node, is obtained by connecting the respective nodes according to a control flow in a method and assumes a structure of the directed graph 55, for example. In one exemplary embodiment, in a case of Java, use of an analysis basis as Soot (http://www.sable.mcgill.ca/soot/index.html)) obtains the program information. “Place” included in the abstract object 53 or the method calling place 54 is assumed to be an identifier unitarily indicating a sentence as a minimum execution unit in the program.

The preprocessing unit 111 applies pointer analysis taking a context into consideration to the program 15 to store a set of the pointer analysis results 52 obtained as a result into the pointer analysis result storage device 122 (Step S12). In one exemplary embodiment, in a case of Java, a pointer analysis result taking a context into consideration can be obtained by the use of an analysis basis of Paddle (http://www.sable.mcgill.ca/paddle/).

The preprocessing unit 111 records a call graph expressing a relationship of method calls obtained by the pointer analysis into the program information storage device 121 (Step S12).

Next, the resource identification unit 112 reads a set of the abstract objects 53 from the program information storage device 121. Out of the abstract objects 53, extract an abstract object 53 whose type coincides with an inspection target class name included in the pattern definition 16 (Step S13).

In another exemplary embodiment, the resource identification unit 112 may extract an abstract object 53 whose type coincides with an inspection target class name included in the pattern definition 16 or coincides with a name of a sub-class of the inspection target class out of the abstract objects 53.

The set of the abstract objects 53 extracted by this Step S13 indicates an object (resource) to be inspected whose pattern is defined by the pattern definition 16. The pattern definition 51 corresponding to the abstract objet 53 is assumed to indicate the pattern definition 16 having an inspection target class name coinciding with the type of the abstract object 53.

Next, the resource identification unit 112 selects one abstract object 53 yet to be processed from the obtained set of abstract objects 53 and transfers the same to the call graph development unit 113 (Step S14). When the processing of all the abstract objects 53 is completed, end the entire processing.

When reading a call graph from the program information storage device 121, the call graph development unit 113 generates a call graph developed from the read call graph (Step S15).

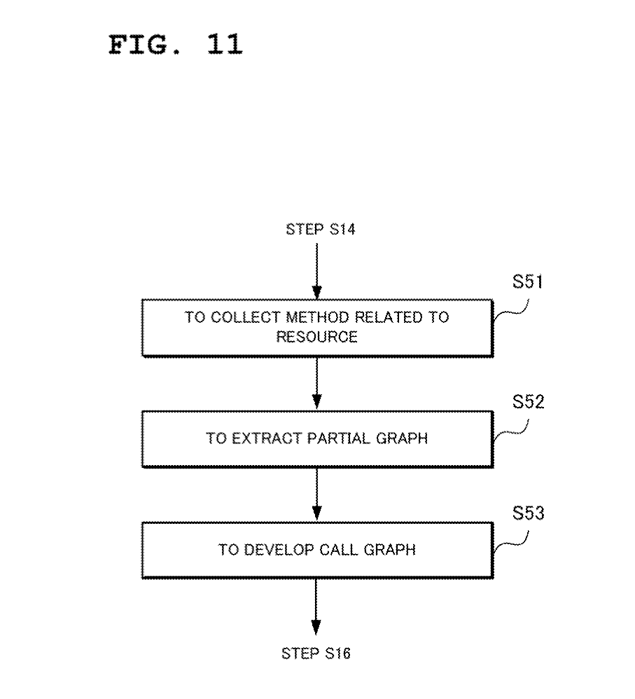

Here, more detailed description will be made of call graph development processing (Step S15) by the call graph development unit 113 with reference to the flow chart of FIG. 11. The flow chart in FIG. 11 shows details of the processing at Step S15.

First, upon reading a set of the method calling places 54 from the program information storage device 121 and a set of the pointer analysis results 52 from the pointer analysis result storage device 122, the call graph development unit 113 extracts only one related to the accepted abstract object 53 from the set of the method calling places 54.

Determination whether the method calling place 54 relates to the abstract object 53 is made by the following manner.

More specifically, when a combination between a variable included in the method calling place 54 and the applied abstract object 53 is included in a set of the pointer analysis results 52 and a method name included in the method calling place 54 is included in a set of inspection target methods of the pattern definition 16 corresponding to the abstract object 53, determination is made that the method calling place 54 relates to the abstract object 53.

Determination whether a combination between a certain variable and an abstract object is included in the set of the pointer analysis results 52 is equivalent to making determination whether a combination of three, the variable, an arbitrary context (including empty context) and the abstract object, is included in the set of the pointer analysis results 52.

The extracted set of the method calling places 54 will be described as a set of method calling places 54 related to inspection of the abstract object 53 or simply as a set of method calling places 54 related to inspection. Method including the method calling place 54 related to the inspection is determined to be a method related to the inspection and collected (Step S51).

Next, extract a partial graph related to the inspection from the read call graph (Step S52).

For the pattern inspection, the present step is not always necessary and the processing may be shifted from Step S51 to Step S53. Since developing a call graph in general leads to a directed graph of an enormous scale, it is preferable to remove an unnecessary part from the present Step for the reduction in a calculation time and an amount of memory to be consumed.

Method including a place included in the accepted abstract object 53 and a method related to inspection of the abstract object 53 will be referred to as “method concerned”. The partial graph is a directed graph and has such a structure, for example, of the directed graph 55 as shown in FIG. 7. Vertex of the partial graph is to include a method concerned and all the methods which will reach a method concerned in the call graph. Manner of calculating a set of nodes reachable from a certain node in the directed graph is widely known.

Next, among pairs (method 1, method 2) included in the directed side of the call graph, include such a pair whose method 2 is included in a set of methods of a vertex of the partial graph into the directed side of the partial graph. Thus obtained partial graph includes all the nodes (methods) included in an arbitrary path reaching a method concerned from an entry point of the call graph and a directed side corresponding to the path.

Next, when omitting the partial graph obtained at Step S52 or the processing of Step S52, develop the call graph (Step S53).

When a recursive method call is included, the partial graph or the call graph will be a directed graph including circulation. In the present exemplary embodiment, therefore, convert each Strongly Connected Component (SCC) in the graph into a non-circular directed graph degenerated into one node and copy a node such that an input side to each node will be one.

Thereafter, by restoring an element of the Strongly Connected Component included in the copied graph so as to maintain an original connection relationship to obtain a developed graph.

Such a development method is recited, for example, in Non-Patent Literature: Ondrej Lhotak, “Program Analysis Using Binary Decision Diagrams”, U.S.A., 2006, McGill University, doctoral dissertation, pp. 104-106 (online: http://plg.uwaterloo.ca/˜olhota/dpubs/thesis-olhotak-phd.ps), which is widely known to those skilled in the art.

Vertex of the developed call graph is formed of a set of pairs of a method and an identifier. Since in the developed call graph, a plurality of methods correspond to one node, identify a different node corresponding to the same method by an identifier. Identifier is accordingly assumed to take a sole value among nodes corresponding to the same method. Directed side is a set of pairs whose element is a pair of a method and an identifier.

The foregoing are details of operation of the call graph development processing at Step S15.

Next, upon accepting the call graph developed by the call graph development unit 113, the abstract object 53 and a set of the method calling places 54 related to inspection of the abstract object 53, the inspection graph generation unit 114 reads the pointer analysis result 52 from the pointer analysis result storage device 122 to generate an inspection graph (Step S16).

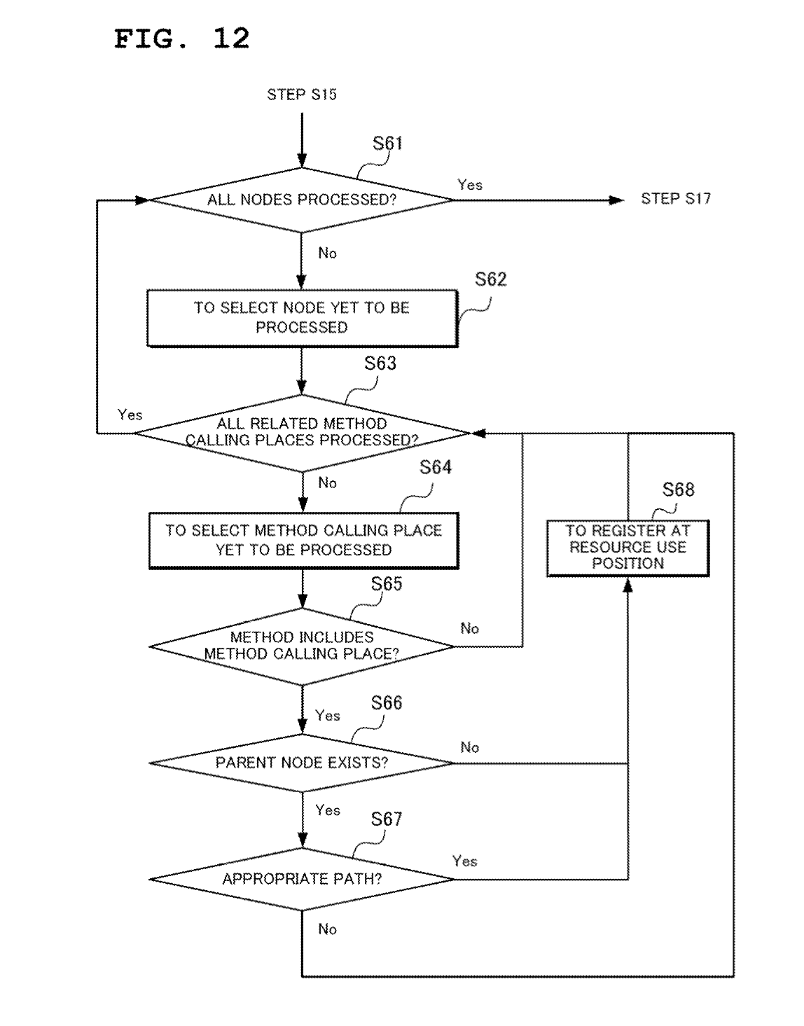

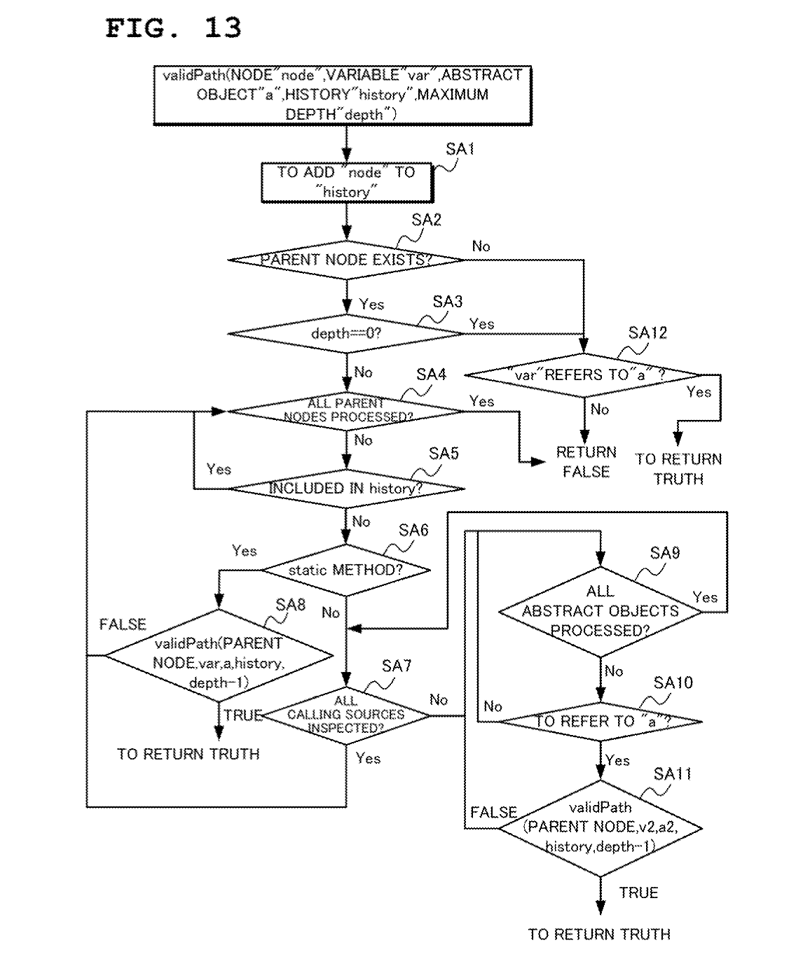

Details of operation for generating the inspection graph will be described with reference to the flow chart of FIG. 12.

First, the inspection graph generation unit 114 selects one node whose processing is yet to be completed from the developed call graph (Steps S61 and S62).

Next, from among the set of the method calling places related to the inspection, select one method calling place yet to be processed (Steps S63 and S64). When there is no method calling place yet to be processed, return to Step S61.

When a method forming the selected node includes the method calling place, move to the processing at Step S66 and when it fails to include the same, return to Step S63 (Step S65).

When a parent node of the selected node exists in the developed call graph, shift the processing to Step S67 and when there exists none, shift to Step S68 (Step S66). Existence of a parent node represents that a directed side of the developed call graph includes a pair of (a parent node and a selected node).

When a parent node exists, determine whether in a context of the node, a variable of the method calling place refers to the abstract object or not (Step S67). Details of the present determination processing will be described later. When determination is made to make reference, return to Step S68 and otherwise, return to Step S63.

At Step S68, add a pair of the node and the method calling place 54 to a set called a resource use position. The pair of a node and a method calling place included in the resource use position has the following characteristics.

More specifically, it is the characteristic that in a context applied by the node, a variable included in the method calling place 54 refers to the abstract object 53 and a method call related to the inspection occurs at the method calling place 54.

When the processing of all the nodes is completed at Step S61, the inspection graph generation unit 114 transfers the generated resource use position (a set of combinations between a node of the developed call graph and a method calling place 54), the developed call graph and the abstract object 53 to the pattern inspection unit 115 to end the processing of Step S16. The resource use position at a stage of the start of Step S16 is assumed to be an empty set.

Lastly, upon receiving the resource use position and the developed call graph, the pattern inspection unit 115 generates a control flow graph bridging over functions and inspects by data flow analysis whether the control flow graph conforms to an inspection pattern of the pattern definition 16 corresponding to the abstract object or not to display the result by using the output device 14 (Step S17).

More detailed description will be made of a pattern inspection method by the pattern inspection unit 115.

Control flow graph bridging over functions is generated by the following manner.

(1) Read an in-function control flow graph of each method forming each node of the developed call graph from the program information recording device 121.
(2) As to all the directed sides (node A, node B) of the developed call graph, draw a directed side from a method calling place of a method forming every B appearing in the in-function control flow graph of a method forming A toward an entry node of the in-function control flow graph of a method forming B.
(3) Draw a directed side from every termination node of the in-function control flow graph of a method forming B toward a method call return place of a method forming a corresponding B of the in-function control flow graph of a method forming. A.

In the above-described example, with a method forming the node A as m1 and a method forming the node B as m2, a control flow graph bridging over the functions can be generated, for example, by drawing a directed side from all the m2 method calling places appearing in the in-function control flow graph of m1 toward an entry node of the in-function control flow graph of m2 and drawing a directed side from all the termination nodes of the in-function control flow graph of m2 toward the corresponding m2 method call return place in the in-function control flow graph of m1.

Although a method of creating a control flow graph bridging over functions is substantially the same as a common pattern inspection system, while the common system generates a control flow graph bridging over functions from a call graph yet to be developed, the pattern inspection system according to the first exemplary embodiment of the present invention differs in generating a control flow graph bridging over functions from a developed call graph.

Out of the obtained control flow graph bridging over functions, record a node corresponding to a place included in the abstract object 53 as a node for generating an inspection target object. Also record, as a node which will make a method call related to a pattern to the abstract object 53, a node included in the resource use position and a node determined by a combination of the method calling places 54. The other nodes will be recorded as a node not related to inspection.

When a node of a developed call graph and the method calling place 54 are applied, first a partial graph corresponding to the node of the developed call graph (an in-function control flow graph corresponding to a method forming the node) is identified from the control flowgraph bridging over the functions and then, a node corresponding to a place included in the method calling place 54 is identified from the partial graph.

As a result, a directed graph (a control flow graph bridging over functions) can be obtained including three kinds of nodes, a node for generating the abstract object 53, a node which will make a method call related to a pattern to the abstract object 53 and the other nodes not related to the inspection.

Then, by data flow analysis, a definite automaton defined by the pattern definition 16 calculates which state can be taken at each node of the directed graph. When the definite automaton assumes other state than a reception state at the termination node of the directed graph, determination will be made that the pattern is violated.

Also when transition not defined in the definite automaton occurs, it can be determined that the pattern is violated. Such determination method by data flow analysis is well known to those skilled in the art.

The foregoing operation enables determination whether a pattern of a method issued to a specific object generated at the time of program execution conforms to an applied pattern rule.

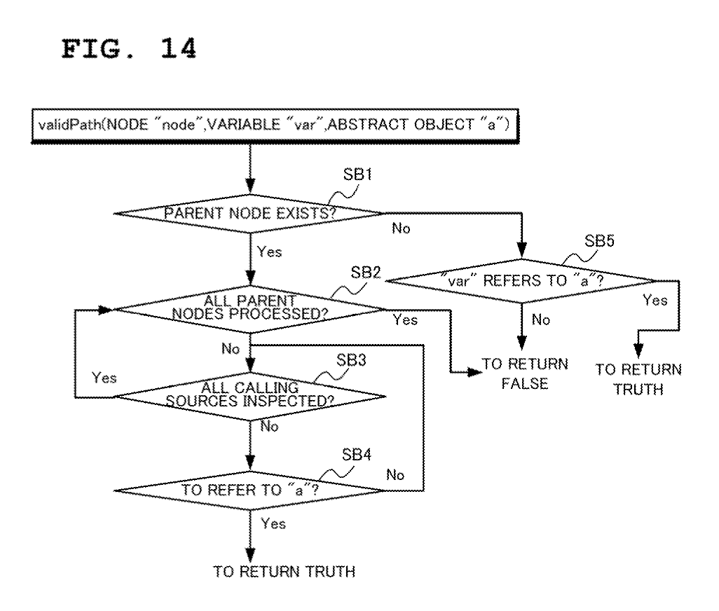

Next, description will be made of detailed operation of Step S67 in the flow chart shown in FIG. 12 which is the processing of the inspection graph generation unit 114 with reference to the flow charts of FIG. 13 and FIG. 14.

At the present step, determination is made by using the pointer analysis result 52 whether a variable of the method calling place 54 in question which has a possibility of referring to the abstract object 53 in question as an inspection target refers to the abstract object 53 in a context applied by the node in question in the developed call graph. The determination method depends on a kind of pointer analysis used.

In the first exemplary embodiment, used is pointer analysis of a kind called object-sensitive. Pointer analysis of this kind is recited in Non-Patent Literature: Ana Milanova and other two persons, “Parameterized Object Sensitivity for Points—to Analysis for Java”, U.S.A., 2005, ACM Transaction on Software Engineering and Methodology, vol. 14, No. 1, pp. 1-41.

In a result of the pointer analysis of this kind, a context is expressed by a string of abstract objects. An object-sensitive pointer analysis result is therefore formed of a combination of three, a variable, an abstract object as a context, and an abstract object. Abstract object as a context is a receiver object of a method in which a variable in question appears. In one exemplary embodiment, in a case of Java, such a pointer analysis result can be obtained by using an analysis basis of Paddle (http://www.sable.mcgill.ca/paddle/).

The flow chart of FIG. 13 shows operation of a function for use in determination in a case where an object-sensitive pointer analysis result is used, which operation includes recursive calling. The function determines whether a path is appropriate or not by tracing a parent node of a call graph searchingly developed from a node in question.

At Step S67, to the above function validPath, apply the node in question, a variable of the method calling place 54, the abstract object 53, an empty list and a numerical value indicative of a depth and when the result is true, determination is made that it is appropriate and when the same is false, determination is made that it is inappropriate.

The numerical value indicative of a depth is used for designating a depth of search. For searching all, the depth should be a value not more than 0. For attaining excellent precision, it is preferable to designate a value not more than 0. It is preferable to designate a depth on the order of 3 taking into performance into consideration.

Details of operation of the function will be described with reference to the flow chart of FIG. 13. Arguments of the function are “node” indicative of a specific node in a developed call graph, a variable “var”, an abstract object “a”, a history “history” and a maximum depth “depth”. The present function determines whether “var” refers to “a” in a context designated by “node”.

First, add “node” to the list “history” indicative of a history (Step SA1).

Next, determine whether a parent node of the “node” exists in the developed call graph and when there exists none, shift to Step SA12 because no context can be obtained. When there exists one, shift to Step SA3 (Step SA2).

At Step SA3, check a depth of search. When the value of “depth” is equivalent to 0, shift to Step SA12 and otherwise, shift to Step SA4.

At Step SA12, determine whether the variable “var” refers to the abstract object “a” or not by using a pointer analysis result. When the combination of three, “var”, an arbitrary context (including an empty context) and “a”, is included in a set of pointer analysis results, return truth and otherwise, return false.

At Step SA4, when among parent nodes of the “node”, there remains a node yet to be processed, select one to shift to Step SA5. When all the parent nodes are processed, return false.

At Step SA5, when the parent node is included in “history”, return to Step SA4. Otherwise, shift to Step SA6.

At Step SA6, determine whether a method forming the “node” in question is a static method or not and when it is a static method, shift to Step SA8 and otherwise, shift to Step SA7.

At Step SA8, recursively apply the parent node, the variable “var”, the abstract object “a”, the history “history” and depth-1 to the present function and when the result is true, return truth and when it is false, return to Step SA4.

In a case of a static method, no receiver object exists. At this time, the present exemplary embodiment is premised on pointer analysis which uses a receiver object of a method which calls up a static method as a context.

As another exemplary embodiment, object-sensitive pointer analysis can be used in which a context is emptied in a case of a static method. In the exemplary embodiment using the pointer analysis of this kind, the operation at Step SA8 changes as follows. At Step SA8, determine whether the variable “var” refers to the abstract object “a” or not by using a pointer analysis result. Then, when a combination of three, “var”, an arbitrary context (including an empty context) and “a”, is included in a set of pointer analysis results, return truth and otherwise return to Step SA4.

At Step SA7, out of the method calling places 54 included in a method forming the parent node, extract a method calling place 54 having a method forming the “node” in question as a method name and apply the processing staring with Step SA9 to each of the extracted places. When the processing of all the extracted method calling places 54 is completed, return to Step SA4.

At Step SA9, obtain a set of abstract objects to which a variable of the selected method calling place 54 refers and apply the processing starting with Step SA10 to each of the objects. When processing of all the elements of the set of the abstract objects is completed, return to Step SA7. Set of abstract objects to which a variable refers can be obtained by collecting abstract objects included in the pointer analysis result 52 including the variable among the pointer analysis results 52. An abstract object selected at the present Step will be called an abstract object a2.

At Step SA10, determine whether with the selected abstract object “a2” as a context, a variable “var” appearing in an argument of the function refers to the abstract object “a” appearing in the argument of the function by using a pointer analysis result. When it refers to the object, shift to Step SA11 and otherwise, shift to Step SA9. When the combination of three, “var”, “a2” and “a”, is included in a set of pointer analysis results, for example, determine that “var” will refer to “a” in the context of a2.

At Step SA11, for further determining whether a variable included in the selected method calling place 54 refers to “a2” in a context applied by the parent node, apply the parent node, the variable included in the selected method calling place 54, “a2”, the history “history” and “depth-1” as arguments to the present function. When a return value of the function is true, return truth and when it is false, return to Step SA9.

The foregoing procedure enables determination whether a variable in question refers to an abstract object in question in a context applied by a node in question by using an object-sensitive pointer analysis result.

In other exemplary embodiment of Step S67 in FIG. 12, used is CFA-type pointer analysis which uses a method calling place as a context. A pointer analysis result of this kind is formed of a combination of three, a variable, a method calling place, and an abstract object. In one exemplary embodiment, in a case of Java, such a pointer analysis result can be obtained by using an analysis basis of Paddle (http://www.sable.mcgill.ca/paddle/).

The flow chart of FIG. 14 shows operation of a procedure-type function for use in determination in a case where a CFA-type pointer analysis result is used, which is used for determining validity of a path at Step S67. Arguments of the function are “node” indicative of a specific node in a developed call graph, a variable “var” and an abstract object “a”. At Step S67, to the function validPath, apply the node in question, a variable included in the method calling place 54, the abstract object 53, an empty list and a numerical value indicative of a depth and when the result is true, determination is made that it is appropriate and when the same is false, determination is made that it is inappropriate. An appropriate value of a numerical value indicative of a depth is the same as that of an object-sensitive analysis.

Details of operation of the function will be described with reference to the flow chart shown in FIG. 14.

First, determine whether a parent node of a “node” exists in a developed call graph and when there exists none, shift to Step SB5 because no context can be obtained. When there exists one, shift to Step SB2 (Step SB1).

At Step SB5, determine whether the variable “var” refers to the abstract object “a” or not by using a pointer analysis result. When the combination of three, “var”, an arbitrary context (including an empty context) and “a”, is included in a set of pointer analysis results, return truth and otherwise, return false.

At Step SB2, when among parent nodes of the “node”, there remains a node yet to be processed, select one to shift to Step SB3. When all the parent nodes are processed, return false.

At Step SB3, among method calling places 54 included in a method forming the parent node, extract such a method calling place 54 having a method forming the “node” in question as a method name and apply the processing of Step SB4 to each of them.

At Step SB4, with the selected method calling place 54 as a context, determine whether the variable “var” refers to the abstract object “a” by using a pointer analysis result. In the determination, when the combination of three, “var”, the selected method calling place 54 and “a”, is included in the pointer analysis result, determination is made that “var” indicates “a” in the present context. When it refers to “a”, return truth and when it fails to refer to the same, return to Step SB3.

The foregoing procedure enables determination whether the variable in question refers to the abstract object in question in the context applied by the node in question by using a CFA-type pointer analysis result.

Both the object sensitive pointer analysis and a CFA-type pointer analysis result are allowed to designate a length of a context to be used. While each of the above-described exemplary embodiments recites operation in a case where the length is 1, when the length is larger than 1, the same determination can be made by searching a further parent node reaching from a parent node until reaching a necessary length of a context and generating a context with respect to the combination of the parent nodes to execute inspection.

### Effects of the First Exemplary Embodiment

Next, effects of the present exemplary embodiment will be described.

Since the present exemplary embodiment is structured to examine which abstract object is to be referred to by a variable appearing on a method calling place by using a pointer analysis result, a pattern of a method call can be inspected which is issued to an object generated at a specific place.

In addition, since the present exemplary embodiment is structured to determine whether a variable appearing in a node on a developed call graph refers to an abstract object to be inspected or not by using a pointer analysis result taking a context into consideration, a pattern can be inspected with high precision.

### Second Exemplary Embodiment

Next, a second exemplary embodiment of the present invention will be described in detail.

The second exemplary embodiment differs from the first exemplary embodiment in using pointer analysis by taking a context into consideration also for an abstract object. A pointer analysis result 56 which is an analysis result of pointer analysis taking a context into consideration also for an abstract object has such a structure as shown in FIG. 8, for example.

Other than the above-described problems, the related pattern inspection system which has been described in the Background Art has a problem that because it is impossible to determine whether a reference variable appearing on a specific path refers to an object generated by a specific path, pattern inspection is impossible while distinguishing objects generated by different execution paths. The pattern inspection system according to the second exemplary embodiment solves such a problem.

The pointer analysis result 56 is formed of a combination of four, a variable, a context 1, an abstract object and a context 2, and in the context 1, the variable is interpreted to refer to an abstract object generated in a case of the context 2. A set of objects generated in a specific context will be referred to as a context abstract object and a context abstract object 57 has such a structure as shown in FIG. 9.

Entire structure of the pattern inspection device 11 of a pattern inspection system according to the second exemplary embodiment is the same as that of the first exemplary embodiment shown in FIG. 1 and a function of each element forming the pattern inspection device 11 differs from that of the first exemplary embodiment in the following manner.

With reference to FIG. 1, difference from the first exemplary embodiment is that the preprocessing unit 111 of the pattern inspection device 11 generates a set of not the pointer analysis results 52 but the pointer analysis results 56 shown in FIG. 8 and generates a set of the context abstract objects 57 shown in FIG. 9 from the inspection target program 15.

Another difference from the first exemplary embodiment is that the resource identification unit 112 extracts not the abstract object 53 related to pattern inspection but the context abstract object 57 related to pattern inspection and inspects elements of the extracted set of the context abstract objects 57 one by one.

Further difference from the first exemplary embodiment is that the call graph development unit 113 extracts the method calling place 54 related to inspection by using not the abstract object 53 but the context abstract object 57.

Still further difference from the first exemplary embodiment is that the inspection graph generation unit 114 discriminates whether a variable refers to the context abstract object 57 or not by using not the abstract object 53 but the context abstract object 57.

Still further difference from the first exemplary embodiment is that the pattern inspection unit 115 determines a node for generating an object to be inspected by using not the abstract object 53 but the context abstract object 57.

Next, detailed description will be made, in particular, of operation of the second exemplary embodiment which is different from that of the first exemplary embodiment with reference to FIG. 10.

Operation of Step S11 is the same as that of the first exemplary embodiment.

Difference at Step S12 from the first exemplary embodiment is that the preprocessing unit 112 generates the pointer analysis result 56 by using pointer analysis taking a context into consideration not only for a reference variable but also for an object to which the reference variable refers and records the result in the pointer analysis result storage device 122. As a preferable exemplary embodiment, in a case of Java, the pointer analysis result 56 can be obtained by using an analysis basis of Paddle (http://www.sable.mcgill.ca/paddle/). Also difference from the first exemplary embodiment is that by using the pointer analysis result 56 or the like, the context abstract object 57 is recorded in the program information storage device 121.

In the second exemplary embodiment, it is inspected on which pattern a method is issued not to the abstract object 53 but to the context abstract object 57.

Difference at Step S13 from the first exemplary embodiment is that the resource identification unit 112 extracts a set of the context abstract objects 57 whose pattern inspection is required by using an inspection target class name of the pattern definition 16. Whether a certain context abstract object 57 is related to a certain pattern definition 16 or not is determined by the same manner as that of the first exemplary embodiment by using information whose type is included in the context abstract object 57.

Difference at Step S14 from the first exemplary embodiment is that the resource identification unit 112 extracts elements of the extracted set of the context abstract objects 57 one by one and transfers the same to the call graph development unit 113.

Operation of the second exemplary embodiment will be described with reference to the flow chart of FIG. 11 which shows operation of Step S15 in more detail.

Difference at Step S51 from the first exemplary embodiment is that when identifying the method calling place 54 and a method related to the inspection, not the abstract object 53 but the context abstract object 57 is used and not the pointer analysis result 52 but the pointer analysis result 56 is used.

When a variable of the method calling place 54 refers to the transferred context abstract object 57, the method calling place 54 relates to the inspection.

Whether a variable of the method calling place 54 refers to the transferred context abstract object 57 or not is determined based on the following conditions.

(1) It is a pointer analysis result 56 including the same variable as the variable of the method calling place 54.
(2) A combination between an abstract object and the context 2 included in the pointer analysis result 56 is equivalent to that of the context abstract object.

When there exists such a pointer analysis result 56 as satisfies the above-described conditions, the method calling place 54 relates to the inspection.

At Step S52, processing is executed by using a set of the method calling places 54 related to the inspection. The operation is the same as that of the first exemplary embodiment. Operation at Step S53 is also the same as that of the first exemplary embodiment.

Next, operation of the second exemplary embodiment will be described with reference to the flow chart of FIG. 12 which shows the operation of Step S16 in more detail. Here, only the operation of Step S67 differs from that of the first exemplary embodiment.

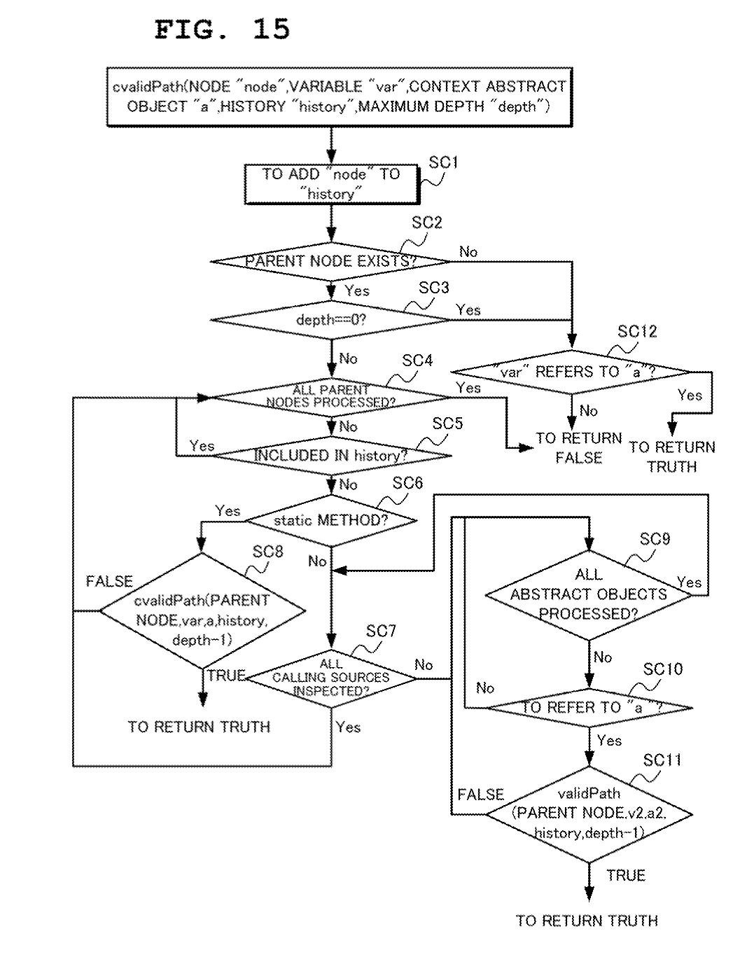

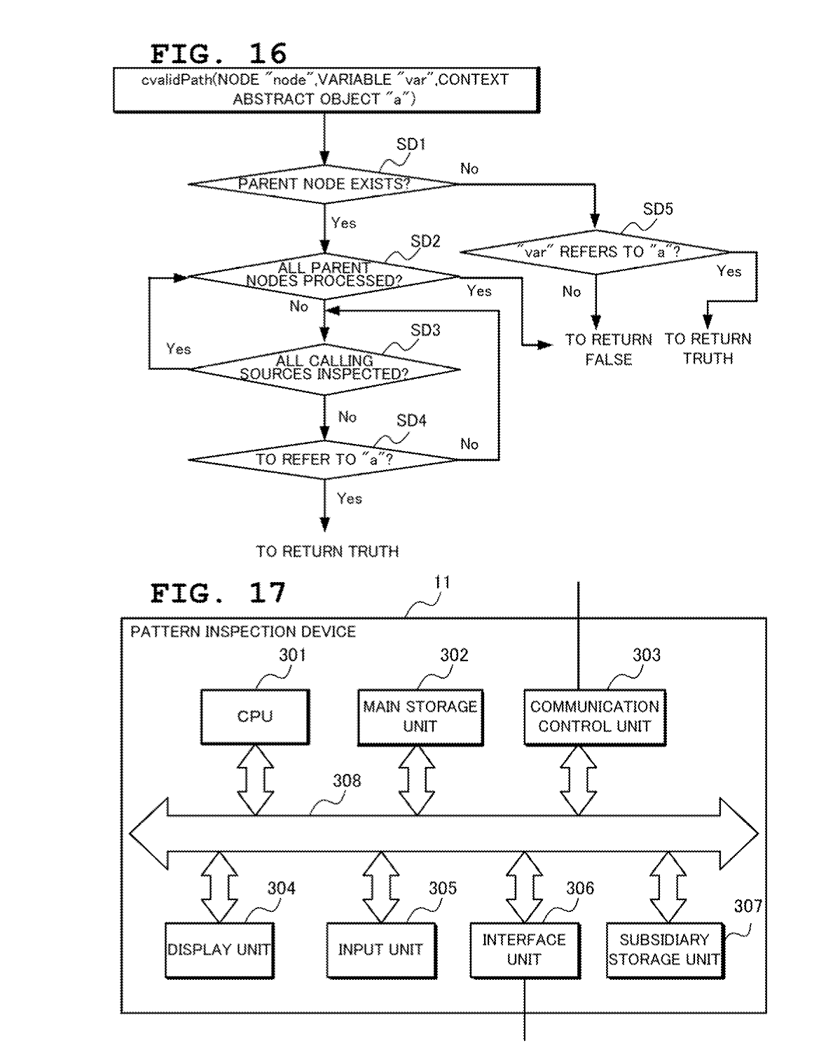

At Step S67, operation changes depending on a kind of pointer analysis result used. Operation of a function for determination according to the second exemplary embodiment to be used in a case where object-sensitive pointer analysis is used is shown in FIG. 15 and operation of a function for determination according to the second exemplary embodiment to be used in a case where CFA-type pointer analysis is used is shown in FIG. 16.

First, details of the operation will be described with reference to the flow chart of FIG. 15.

Function cvalidPath has, as arguments, a node “node” of a developed call graph, a variable “var”, a context abstract object “a”, a history “history” and a maximum depth “depth”. cvalidPath returns truth when the variable “var” refers to the context abstract object “a” in a context applied by the “node” and otherwise, returns false.

Steps SC1, SC2, SC3, SC4, SC5, SC6 and SC7 are the same as operation Steps SA1, SA2, SA3, SA4, SA5, SA6 and SA7 of the function validPath according to the first exemplary embodiment shown in FIG. 13, respectively.

Step S8 recursively applies as arguments, to cvalidPath, a parent node selected at Step SC4, a variable “var” applied as an argument, the context abstract object 57 applied as an argument, “history” and “depth-1” and when a return is true, return truth and when it is false, return to Step SC4.

At Step SC9, obtain a set of the abstract objects 53 to which a reference variable of the method calling place 54 selected at Step SC7 refers and apply the processing starting with Step SC10 to each of them.

Method of obtaining a set of the abstract objects 53 to which a reference variable of the method calling place 54 refers by using the pointer analysis result 56 is as follows.

Calculate a set of abstract objects 53 included in the pointer analysis result 56 including the same variable as a variable included in the method calling place 54.

At Step SC10, with the abstract object 53 selected at Step SC9 by using the pointer analysis result 56 as a context, determine whether the variable “var” applied as an argument refers to a context abstract object “a” applied as an argument.

When a combination of four, the variable “var”, the abstract object 53, an abstract object included in the context abstract object “a” and a context included in the context abstract object “a”, is included in the set of the pointer analysis results 56, determine that the variable “var” refers to the context abstract object “a” in the context of the abstract object. When the variable refers to the object, proceed to Step SC11 and otherwise, return to Step SC9.

At Step SC11, apply the function validPath shown in FIG. 13 which is used in the first exemplary embodiment by using, as arguments, the parent node selected at Step SC4, a variable included in the method calling place 54 selected at Step SC7, the abstract object selected at Sep SC9, “history” and “depth-1”.

When a return value is true, return truth and when it is false, return to Step SC9. Although validPath is defined for the pointer analysis 52, since the pointer analysis 56 has information including the pointer analysis 52, it can be applied similarly. It is possible, for example, to calculate a set of abstract objects to which a certain variable refers by using the pointer analysis result 56 as described above.

Next, operation of a function for determination according to the second exemplary embodiment to be used in a case where CFA-type pointer analysis is used is shown in the flow chart of FIG. 16.

cvalidPath is a function which, upon receiving a node “node” of a developed call graph, a variable “var” and a context abstract object “a” as arguments, when the variable “var” refers to the context abstract object “a” in the context applied by “node”, returns truth and otherwise, returns false.

Steps SD1, SD2 and SD3 are the same as the operation Steps SB1, SB2 and SB3 of the function validPath according to the first exemplary embodiment shown in FIG. 14, respectively.

At Step SD4, with the method calling place 54 selected at Step SD3 as a context, by using the pointer analysis result 56, determine whether the variable “var” refers to the context abstract object “a” or not and when the variable refers to the object, return truth and otherwise, return to Step SD3.

Determine whether a combination of four, the variable “var”, the method calling place 54, an abstract object included in the context abstract object “a” applied as an argument and a context included in the context abstract object “a” which is applied as an argument, is included in the pointer analysis results 56, and when it is included, determine that “var” refers to “a”.

At Step SD5, determine whether the variable “var” refers to the context abstract object “a” or not by using the pointer analysis result 56. When the combination of four, “var”, an arbitrary context (including an empty context), an abstract object included in “a” and a context included in “a”, is included in the set of the pointer analysis results 56, return truth and otherwise, return false.

Next, operation of the pattern inspection (Step S17 in FIG. 10) according to the second exemplary embodiment will be described.

The pattern inspection unit 115 according to the second exemplary embodiment differs from that of the first exemplary embodiment in operation of identifying a place at which an inspection target object is to be generated after generation of a control flow graph bridging over functions.

In the second exemplary embodiment, an inspection target object is the context abstract object 57. Method for identifying a node for generation changes with which is used as a context of the abstract object.

Although possible combinations of kinds of contexts used as the context 1 and the context 2 included in the pointer analysis result 56 are four, between object-sensitive and object-sensitive, object-sensitive and CFA-type, CFA-type and object-sensitive, and CFA-type and CFA-type, the combination between CFA-type and object-sensitive has no significance, an exemplary embodiment with respect to the remaining three kinds will be described.

First, description will be made of an exemplary embodiment using pointer analysis which uses a context of a combination between object-sensitive and object-sensitive for a reference variable and an abstract object. This combination is most suitable.

First, inspect all the nodes in a call graph developed corresponding to a method including a place included in the context abstract object 57 to be inspected.

The inspection method is as follows. When a context included in the context abstract object 57 is empty, return truth and otherwise, apply, to the function validPath shown in FIG. 13, a parent node of a node in question, a variable “var” of a method calling place 54 for calling up a method forming the node in question included in the parent node of the node in question and, an abstract object included in the context abstract object 57 and when there exists the method calling place 54 included in a parent node whose return value is true, return truth as a result of the present inspection and otherwise, return false. As to a node whose inspection result will be true, record, as nodes for generating an inspection target object; the node in question and a node in a between-function control flow graph identified by a place included in the context abstract object 57.

Next, description will be made of an exemplary embodiment using pointer analysis using a context of a combination between object-sensitive and CFA-type for a reference variable and an abstract object or pointer analysis using a context of a combination between CFA-type and CFA-type.

Context included in the context abstract object 57 is the method calling place 54. First, inspect all the nodes in a developed call graph corresponding to a method including a place included in the context abstract object 57 to be inspected.

Inspection methods are as follows. When in a parent node of a node in question, there exists a node including a place included in the method calling place 54 of a context included in the context abstract object 57 in question, return truth and otherwise, return false. With respect to a node whose inspection result will be true, record the node in question and a node in a between-function control flow graph identified by the place included in the context abstract object 57 as nodes for generating an inspection target object.

### Effects of the Second Exemplary Embodiment

Next, effects of the second exemplary embodiment will be described.

While the related pattern inspection system described in the Background Art has a problem that since it is impossible to determine whether a reference variable appearing on a specific path refers to an object generated by the specific path or not, inspection of patterns while distinguishing an object generated by a different execution path is impossible, because the present second exemplary embodiment is structured to inspect objects generated at the same place as different inspection target objects whose context is different, it is possible to inspect a pattern while distinguishing objects generated by different execution paths.

More specifically, the reason is that by using a pointer analysis result taking a context into consideration for an abstract object, a pattern of a method calling is inspected which is issued by a reference variable that refers to an abstract object generated in a specific context.

Depth-1 appearing in the present description represents a value obtained by subtracting one from a value of a variable “depth”.

Although the inspection graph generation unit 114, when using an object-sensitive pointer analysis result, uses a history “history” for the processing of the function validPath in the operation described with reference to FIG. 13, it does not necessarily need to use a history as long as a maximum depth is designated. Accordingly, the processing of Steps SA1 and SA5 shown in FIG. 13 will be omitted.

Also in the processing of validPath shown in FIG. 13, not a node of a developed call graph but a pair of a developed call graph and an abstract object may be used as a history. In this case, eliminate the processing of Step SA1 and Step SA5 shown in FIG. 13 and newly add a new step between Steps SA6 and SA8. At this new step, determine whether a combination between the node and null is included in the history “history” or not and when it is included, return to Step SA4 and when it is not included, add the pair of the node and null to the history “history” to shift to the processing of Step SA8.

Further add a new step between Step SA10 and Step SA11. At this new step, determine whether a pair of the node in question and an abstract object selected at Step SA9 is included in the history “history” and when it is included, return to Step SA9 and when it is not included, add the pair of the node and the abstract object to the history “history” to shift to the processing of Step SA11. This realizes the processing of validPath using a node of a graph developed in the history and an abstract object as a history.

Also as a history of the function cvalidPath that the pattern inspection unit shown in FIG. 15 uses, a pair of a node of a graph developed by the same modification and an abstract object can be used as a history.

While the present invention has been described with respect to the preferred exemplary embodiments and modes of implementation in the foregoing, the present invention is not necessarily limited to the above-described preferred exemplary embodiments and modes of implementation but can be implemented in various forms without departing from the spirit and scope of its technical idea.

### INCORPORATION BY REFERENCE

This application is based upon and claims the benefit of priority from Japanese patent application No. 2007-201584, filed on Aug. 2, 2007, the disclosure of which is incorporated herein in its entirety by reference.

### INDUSTRIAL APPLICABILITY

The present invention is applicable to a pattern inspection device which detects a part violating pattern definition from a program, and allows the pattern inspection function to be applied to such usage as a program development environment warning function or a complementary function.

1-31. (canceled)

32. A pattern inspection system for inspecting, with a program described in an object-oriented language as a target, a calling pattern of a method issued to an object generated when the program is executed, comprising:
data of pattern definition that defines a class name to be inspected and a calling pattern of a method to be inspected;
an extraction unit for extracting an abstract object related to said class name to be inspected from abstract objects used in said program;
a determination unit for determining a method calling place at which calling of a method issued to said abstract object extracted is made by executing pointer analysis taking a context into consideration;
an inspection unit for, by generating a control flow graph of calling of a method bridging over methods used for said method calling place and executing data flow analysis with respect to the graph, inspecting whether a calling pattern of said method conforms to said calling pattern to be inspected or not; and
an output unit for outputting a result of said inspection.

33. The pattern inspection system according to claim 32, comprising:
a unit for obtaining said pointer analysis result by applying pointer analysis taking said context into consideration;
a pointer analysis result storage device for storing a pointer analysis result of said program, and
a program information storage device for storing said abstract object, said method calling place and said control flow graph.

34. The pattern inspection system according to claim 32, comprising:
a call graph development unit for generating a developed call graph by executing pointer analysis taking a context into consideration to identify a method calling place at which calling of a method issued to said abstract object extracted is made; and
an inspection graph generation unit having a function of determining whether a variable included in said method calling place refers to said abstract object in a context applied by each node of said developed call graph or not.

35. The pattern inspection system according to claim 34, comprising:
a unit for obtaining said pointer analysis result by applying pointer analysis taking said context into consideration;
a pointer analysis result storage device for storing said pointer analysis result; and
a program information storage device for storing said abstract object, said method calling place, said control flow graph and a call graph.

36. The pattern inspection system according to claim 32, wherein said pointer analysis result obtained by object-sensitive pointer analysis is used.

37. The pattern inspection system according to claim 32, wherein said pointer analysis result obtained by CFA-type pointer analysis is used.

38. The pattern inspection system according to claim 32, comprising:
a resource identification unit for extracting a context abstract object related to said class name to be inspected from context abstract objects used in said program;
a call graph development unit for generating a developed call graph by executing pointer analysis taking a context into consideration to identify a method calling place at which calling of a method issued to said context abstract object extracted is made;
an inspection graph generation unit having a function of determining whether a variable included in said method calling place refers to said context abstract object in a context applied by each node of said developed call graph or not;
a pattern inspection unit for, by determining whether said context abstract object is generated in a context applied by each node of said developed call graph and generating a control flow graph of calling of a method bridging over methods used for said method calling place to execute data flow analysis with respect to the graph, inspecting whether a calling pattern of said method conforms to said calling pattern to be inspected or not.

39. The pattern inspection system according to claim 38, comprising:
a unit for obtaining said pointer analysis result by applying pointer analysis taking a context into consideration to a reference variable and an abstract object,
a pointer analysis result storage device for storing said pointer analysis result, and
a program information storage device for storing said context abstract object, said method calling place, said control flow graph and a call graph.

40. A pattern inspection device for inspecting, with a program described in an object-oriented language as a target, a calling pattern of a method issued to an object generated when the program is executed, comprising:
data of pattern definition that defines a class name to be inspected and a calling pattern of a method to be inspected;
an extraction unit for extracting an abstract object related to said class name to be inspected from abstract objects used in said program;
a determination unit for determining a method calling place at which calling of a method issued to said abstract object extracted is made by executing pointer analysis taking a context into consideration;
an inspection unit for, by generating a control flow graph of calling of a method bridging over methods used for said method calling place and executing data flow analysis with respect to the graph, inspecting whether a calling pattern of said method conforms to said calling pattern to be inspected or not; and
an output unit for outputting a result of said inspection.

41. The pattern inspection device according to claim 40, comprising:
a call graph development unit for generating a developed call graph by executing pointer analysis taking a context into consideration to identify a method calling place at which calling of a method issued to said abstract object extracted is made; and
an inspection graph generation unit having a function of determining whether a variable included in said method calling place refers to said abstract object in a context applied by each node of said developed call graph or not.

42. The pattern inspection device according to claim 40, comprising:
a resource identification unit for extracting a context abstract object related to said class name to be inspected from context abstract objects used in said program;
a call graph development unit for generating a developed call graph by executing pointer analysis taking a context into consideration to identify a method calling place at which calling of a method issued to said context abstract object extracted is made;
an inspection graph generation unit having a function of determining whether a variable included in said method calling place refers to said context abstract object in a context applied by each node of said developed call graph or not; and
a pattern inspection unit for, by determining whether said context abstract object is generated in a context applied by each node of said developed call graph and generating a control flow graph of calling of a method bridging over methods used for said method calling place to execute data flow analysis with respect to the graph, inspecting whether a calling pattern of said method conforms to said calling pattern to be inspected or not.

43. A pattern inspection method of inspecting by a computer, with a program described in an object-oriented language as a target, a calling pattern of a method issued to an object generated when the program is executed, including
data of pattern definition that defines a class name to be inspected and a calling pattern of a method to be inspected,
wherein said method comprising the steps of:
a step of extracting an abstract object related to said class name to be inspected from abstract objects used in said program;
a step of determining a method calling place at which calling of a method issued to said abstract object extracted is made by executing pointer analysis taking a context into consideration;
a step of, by generating a control flow graph of calling of a method bridging over methods used for said method calling place and executing data flow analysis with respect to the graph, inspecting whether a calling pattern of said method conforms to said calling pattern to be inspected or not; and
a step of outputting a result of said inspection.

44. The pattern inspection method according to claim 43, comprising:
a step of obtaining said pointer analysis result by applying pointer analysis taking a context into consideration to said program.

45. The pattern inspection method according to claim 43, comprising:
a step of generating a developed call graph by executing pointer analysis taking a context into consideration to identify a method calling place at which calling of a method issued to said abstract object extracted is made; and
a step of determining whether a variable included in said method calling place refers to said abstract object in a context applied by each node of said developed call graph or not.

46. The pattern inspection method according to claim 45, comprising:
a step of obtaining said pointer analysis result by applying pointer analysis taking a context into consideration to said program.

47. The pattern inspection method according to claim 43, wherein said pointer analysis result obtained by object-sensitive pointer analysis is used.

48. The pattern inspection method according to claim 43, wherein said pointer analysis result obtained by CFA-type pointer analysis is used.

49. The pattern inspection method according to claim 43, comprising:
a step of extracting a context abstract object related to said class name to be inspected from context abstract objects used in said program;
a step of generating a developed call graph by executing pointer analysis taking a context into consideration to identify a method calling place at which calling of a method issued to said context abstract object extracted is made;
a step of determining whether a variable included in said method calling place refers to said context abstract object in a context applied by each node of said developed call graph or not; and
a step of, by determining whether said context abstract object is generated in a context applied by each node of said developed call graph and generating a control flow graph of calling of a method bridging over methods used for said method calling place to execute data flow analysis with respect to the graph, inspecting whether a calling pattern of said method conforms to said calling pattern to be inspected or not.

50. The pattern inspection method according to claim 49, comprising a step of obtaining said pointer analysis result by applying pointer analysis taking a context into consideration to a reference variable and an abstract object.
